(19) United States
(12) Patent Application Publication
(10) Pub. No.: US 2007/0055847 A1
(43) Pub. Date: Mar. 8, 2007

(54) Operational processor with a status information register serving as a data register

(75) Inventors: Masaru Nagase, Saitama (JP); Makoto Ohnishi, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/515,905

(22) Filed: Sep. 6, 2006

(30) Foreign Application Priority Data
Sep. 8, 2005 (JP) 2005-260581

(51) Int. Cl. G06F 9/44

(52) U.S. Cl. 712/220

(57) ABSTRACT

The operational processor includes a general-purpose register that holds data associated with operation processing, and a program status register that holds information associated with the status of the operational processor. The data and information are saved during interrupt processing or task switching. The program status register holds in its bit positions C1-Cn a portion of data resulting from the operation processing. The held data are the n most significant bits of the least significant bits of the data resulting from the operation processing which are not held in the general-purpose register, and are for use in the operation. The operational processor may perform fewer operations than the double precision operation, and improve the operation precision without increasing the task switching time.

### BACKGROUND OF THE INVENTION

1. Field of the Invention

The present invention relates to an operational processor and an information processor that have a program status register (PSR) serving as an internal register, and in particular, to such an operational processor and an information processor with operational precision improved. The program status register is also referred to as a program status word (PSW), a processor status word, a flag register or a control register.

2. Description of the Background Art

A microcomputer, which is a sort of information processor, a microcontroller, which is a sort of microcomputer for use in control, and the like include an operational processor such as a microprocessor which is a CPU (Central Processor) implemented in the form of LSI (Large-Scale Integration). An operating system that supports a multitasking can usually run on the operational processor. Such an operating system includes, for example, the real time operating system (RTOS), which allows a real-time processing.

Such an operating system has a scheduler, which determines the order of executing tasks, and a dispatcher, which switches tasks according to the execution order after a predetermined time has passed. The scheduler and dispatcher are implemented in the form of software. The dispatcher determines which task is to be executed the next time.

Switching tasks during processing operation needs to temporarily save the memory content of an internal register of the operational processor, the internal register holding an intermediate result from the operation and so on. The internal register includes a general-purpose register, a program counter, an instruction register, a register associated with pipeline processing, a program status register (hereinafter simply referred to as a “status register”) and so on.

The status register holds, for example, a flag. The flag results from the operation executed by an arithmetic and logical unit (ALU) etc., in the microprocessor. The flag includes a carry flag (C), a sign flag (S), a zero flag (Z), an interrupt control flag (E) and so forth. The carry flag indicates whether or not there is a carry. The sign flag indicates whether data are positive or negative. The zero flag indicates whether or not data are zero. The status register is usually configured as an aggregate of the flags, although the flags may be provided separately.

The data inputted or outputted to or from the arithmetic and logical unit and so on have the same number of bits as the system bus which is also referred to as a CPU bus. Data and a flag resulting from operation is stored in a predetermined register and the status register, respectively, for use in operation and so forth at the next step.

An operation method in an operational processor is disclosed, for example, in Japanese patent laid-open publication No. 259273/1999. The publication discloses a method for performing fewer operations in determining a product of data A and data B with a double precision by dividing the data A into upper data A and lower data A and dividing the data B into upper data B and lower data B to multiply them.

The above-described flags are adapted to store operational results obtained by an operational processor. When an operation forms part of consecutive operation and is frequently executed, however, a referencing of the flags alone may not provide a sufficient operation precision. For example, when operations are performed in several times, as in the case of operation, A×B×C, the operation precision may be degraded as the operations proceed because the register has its size fixed to, for example, 16 bits.

This will be further described below. Consider that the CPU bus is of 16 bits in width and that operation results in data having the data length thereof equal to 32 bits. An operation of multiplying sets of data, each having its data length equal to 16 bits, with each other will provide data having the data length equal to 32 bits. A CPU bus of 16 bits can only provide the operational result of the 16 most significant bits. Further multiplying the operational result by data of the 16-bit length will decrease the operation precision because the 16 least significant bits of the operational result are unused in the operation.

The technology described in the above-mentioned Japanese publication uses the double precision operation to increase the operation precision. The double precision operation may provide a higher operation precision than a single precision operation. The double precision operation, however, performs more operations than the single precision operation, thereby rendering the operation speed decreasing.

The lowered precision problem will be encountered in the fixed decimal point representation when the CPU bus has 16 bits in length with the bit length specified less than 16 bits in an operation. For example, multiplying sets of 15 bits of data (hereinafter referred to as “Q15 data”) will result in 32-bit data whose two most significant bits are “00”. The 16 most significant bits of the 32-bit data are outputted as the intermediate result of the operation processing. The 16-bit data have the two most significant bits being “00”.

However, the most significant one of those 16 most significant bits is unnecessary, so that the operation result will be shifted to the left by one bit position. The shift to the left should have caused the least significant bit position in those 16 most significant bits to receive the most significant one of the 16 least significant bits, which has already been discarded during the computation. The shift to the left would not insert the most significant one of the 16 least significant bits into the least significant bit position of the 16 most significant bits.

Likewise, multiplying sets of Q14 data, i.e. 14-bit data, and multiplying sets of Q13 data, i.e. 13-bit data, provide a shift to the left by two bits and three bits, respectively, during computation. Again, the shift would not receive two or three bits from the 16 least significant bits. A problem thus arises that shifting by more bit positions may cause lower operation precision.

In some of the conventional 16-bit microcomputers whose CPU bus is of 16 bits in width, multiplying sets of 16-bit data results in 32-bit data whose 16 most significant bits and 16 least significant bits are stored in registers separate from each other. Such microcomputers are not structured to discard the 16 least significant bits. The operation precision can therefore be maintained. In this case, however, the task switching requires both of the 16 most significant bits and the 16 least significant bits to be saved from the registers to a memory, which takes time for switching tasks.

### SUMMARY OF THE INVENTION

It is therefore an object of the present invention to provide an operational processor that performs fewer operations than the double precision operation and that improves the operation precision without increasing the task switching time.

The present invention provides an operational processor comprising a data register that holds data associated with operation processing, and a status information register that holds information associated with the status of the operational processor, the data and information being saved from the data register and status information register to an external storage at least on task switching, wherein the status information register holds a portion of data resulting from the operation processing, the held data are at least a portion of lower bits of the data resulting from the operation processing, the lower bits not being held in the data register, and the operational processor comprises: a circuit for allowing the status information register to hold the portion of the bits; and a circuit for allowing the status information register to output the portion of the data.

According to the present invention, the status information register does not discard but holds at least a portion of the lower bits of the data resulting from the operation processing, the lower bits not being held in the data register, thereby using the held bits to increase the operation precision. Further, because the status information register holds the lower bits, no additional data register is necessary for holding the lower bits.

Further, because the status information register is used from which data would conventionally be intended to be saved, data amount to be saved on task switching does not substantially increase, thereby avoiding the period of time for task switching from increasing. Because the conventional double precision operation is not performed, fewer registers are used, thereby performing fewer operations than in the double precision operation.

The present invention may provide, compared to the double precision operation, fewer operations, less processing burden during register saving on the occasion of interrupt or task switching, and a higher operation precision.

### BRIEF DESCRIPTION OF THE DRAWINGS

The objects and features of the present invention will become more apparent from consideration of the following detailed description taken in conjunction with the accompanying drawings in which:

FIG. 1A schematically illustrates a configuration of the status register of an embodiment of the present invention;

FIG. 1B schematically illustrates a configuration of the status register of a comparative example;

FIG. 2 outlines the operation processing of the embodiment of the present invention;

FIG. 3 outlines the operation processing in the comparative example;

FIG. 4 is a schematic block diagram of the operational processor of the embodiment;

FIG. 5 is a timing chart of the operational processor shown in FIG. 4;

FIG. 6 outlines the operation processing of another comparative example;

FIG. 7 outlines the operation processing of an alternative embodiment of the present invention;

FIG. 8 is a schematic block diagram of the operational processor of the alternative embodiment; and

FIG. 9 is a timing chart of the operational processor shown in FIG. 8.

### DESCRIPTION OF THE PREFERRED EMBODIMENTS

Referring now to the accompanying drawings, embodiments of the operational processor according to the present invention will be described in more detail. A microcontroller, which is an information processor, includes the embodiments of the operational processor according to the present invention, where the CPU (Central Processor Unit) bus is of 16 bits. The present invention is not limited to 16 bits, but the CPU bus may be of 32 bits, 64 bits or more.

The operational processor comprises a plurality of 16-bit general-purpose registers that are arranged to hold data about operation processing, and a status register that is adapted to hold information about the status of the operational processor. When processing an interrupt or switching tasks, the operational processor saves data and information in a hard disk provided in an information processor.

The status register is adapted to hold a portion of data resulting from operation processing. The held data are at least a portion of the least significant bits of data which are resultant from the operation processing and not held in the general-purpose register. The operational processor comprises a control section. The control section allows the status register to hold and output the aforementioned portion of the data. The control section decodes and interprets a program sequence stored in a memory in the microcontroller to control data input and output between the general-purpose register, the status register, the operating circuitry and the memory, and instruct the operating circuitry to perform operations. The operating circuitry includes a multiplier, arithmetic and logical unit (ALU) and so on as described below.

The instant embodiment is configured to multiply sets of 16-bit data. The data resulting from the multiplication has 32 bits in length, which exceed 16 bits that are the data length of which data the general-purpose register can hold. The general-purpose register holds the 16 most significant bits of the 32-bit data, which 16-bit data can be held by the general-purpose register. The status register holds the n most significant bits of the 16 least significant bits of data which are not held in the general-purpose register. In this embodiment, n is a natural number ranging from one to 16, inclusive, for example, five. The value n may be fixed before shipping of the operational processor, or may not be fixed so that a user may specify it to any desired value.

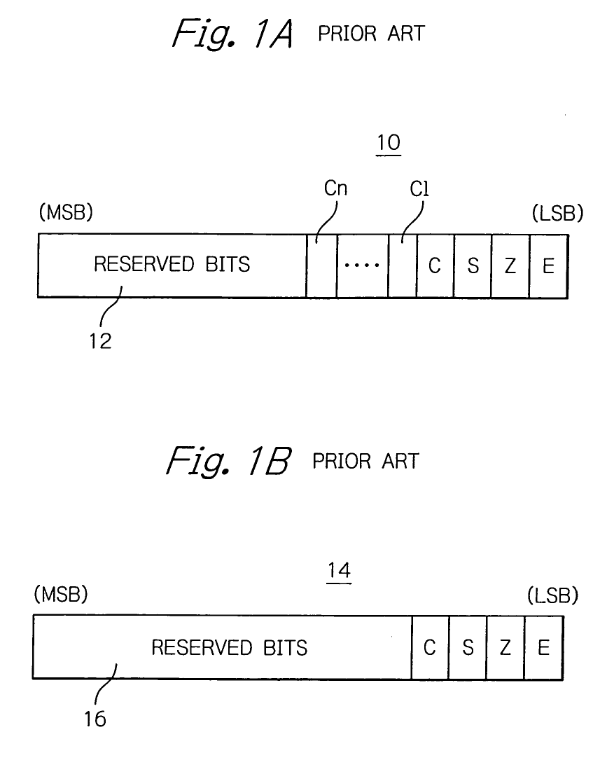

FIG. 1A shows a configuration of the status register 10 of the embodiment. The status register 10 includes bit positions C1-Cn in the regions that were conventionally intended to be reserved. The bit positions C1-Cn are prepared for storing the n most significant bits of the 16 least significant bits of the 32 bits of operational result from the operation made between sets of 16-bit data. The reserved bit positions were conventionally intended to be unused. In FIGS. 1A and 1B, the leftmost bit is the most significant bit (MSB), and the rightmost bit is the least significant bit (LSB). FIG. 1A shows the reserved bit positions 12 formed by a predetermined number of bits continuing from the most significant bit, and the four least significant bits including a carry flag C, a sign flag S, a zero flag Z and an interrupt control flag E. Each of the reserved bits 12 is fixed to a value of “00”.

FIG. 1B shows, as a comparative example, a configuration of a status register 14 without bit positions C1-Cn. It has a predetermined number of reserved bit positions 16 continuing from the most significant bit, and the four least significant bits including a carry flag C, a sign flag S, a zero flag Z and an interrupt control flag E.

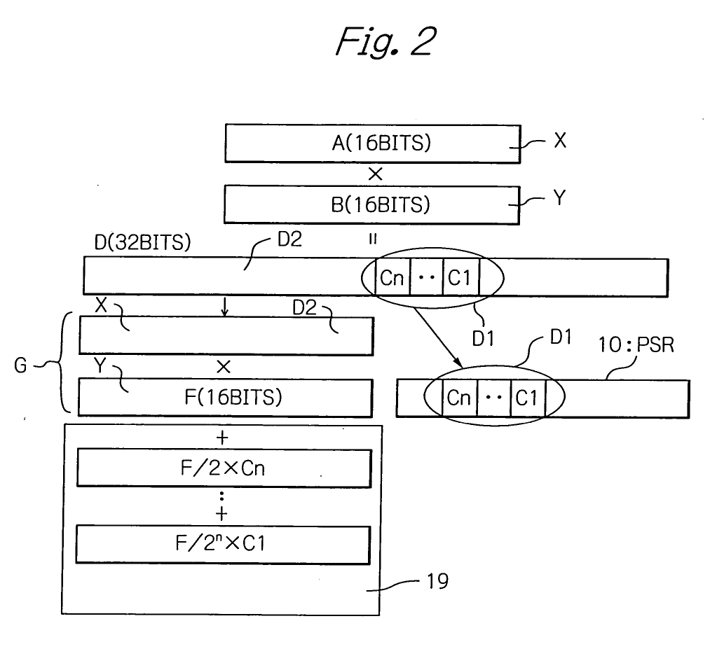

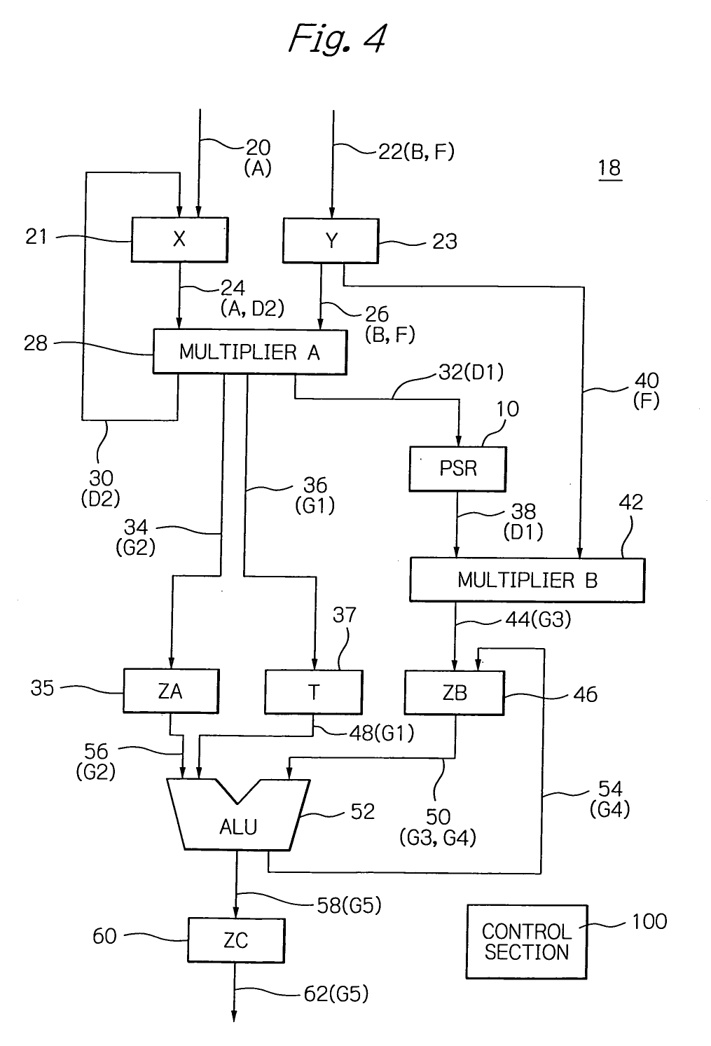

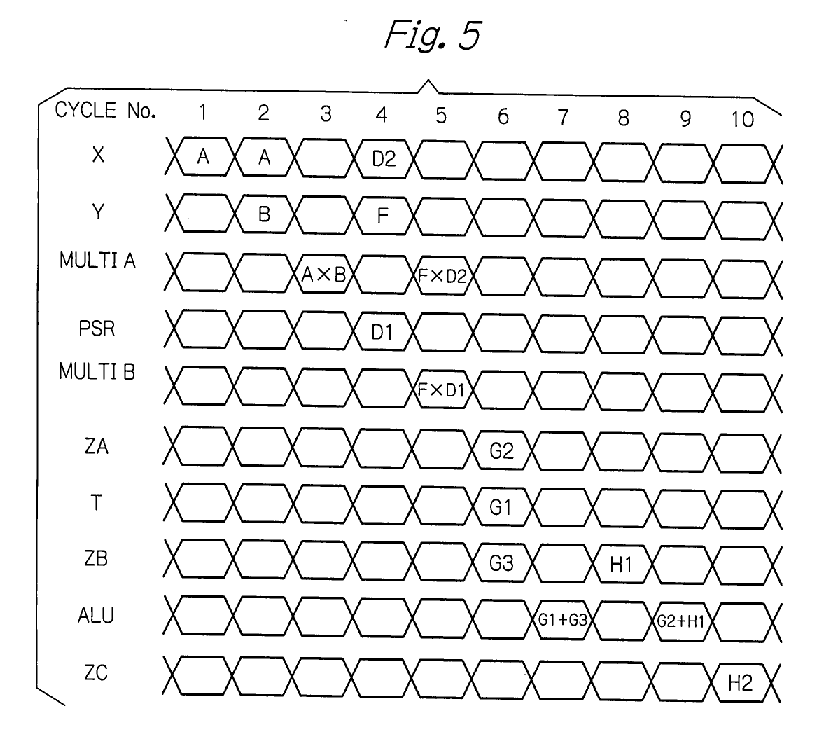

FIG. 2 outlines the operation processing of the present embodiment. This embodiment multiplies three sets of data A, B and F to provide a product of A×B×F. It is supposed now that each of the data A, B and F are of 16 bits. This embodiment firstly provides a product of A×B (=D). This embodiment then multiplies the 16 most significant bits (D2) of the 32 bits of resultant product D (=A×B) with the data F to obtain a product G, as well as multiplies the n bits (D1) of the 16 least significant bits of the product D with the data F to obtain a product 19. This embodiment then adds the products G and 19 to each other to output the resultant sum as the answer of the product of A×B×F. To perform the above-described operations, the operational processor in the instant embodiment has registers X, Y, ZA, ZB and T, a multiplier, and an arithmetic and logical unit (ALU) and so on. The registers X, Y, ZA, ZB and T, the multiplier, and the arithmetic and logical unit will be described below in more detail with reference to FIGS. 4 and 5.

A further description will be given on the operation processing. The processing first multiplies the 16-bit data A and 16-bit data B that are held in the registers X and Y, respectively, to provide 32-bit data D. Because the CPU bus has a width of 16 bits, the processing actually holds the 16 upper bits of data D2 of the data D in the register X as a computation result. The processing also holds the n most significant bits of data D1 of the 16 least significant bits of the data D in the bit positions C1-Cn of the status register 10.

At the next step, the processing multiplies the 16 most significant bits of data D2 of the data D by the 16 bits of data F held in the register Y to provide 32-bit data G (=F×D2). The 16 most significant bits of data G2 of the data G will be held in the register ZA, and the 16 least significant bits of data G1 of the data G will be held in the register T.

The processing also multiplies the data D1 by the 16-bit data F held in the register Y to provide 32 or less bits of data (=F×D1). More specifically, an operation of F/2×Cn+ . . . +F/2ⁿ×C1 is performed. Only the 16 upper bits of data G3 of the resulting data will be held in the register ZB. The processing then adds the data G1 in the register T to the data G3 in the register ZB to provide a sum G4. The processing further adds the data G2 in the register ZA to the sum G4 to provide a sum G5. The sum G5 is the product of A×B×F.

All of the registers x, Y, T, ZA, and ZB may be general-purpose registers. The processing may save values stored in the general-purpose registers and status register when encountering an interrupt or switching task during operation, as in the conventional technology.

In this way, the instant embodiment provides the product of the data F and the 16 most significant bits of the product D (=A×B), and provides the product of the data F and n bits of the 16 least significant bits of the product D, and then adds the two products to each other. This embodiment may thus accomplish a higher computation precision than a method that would not take into account the 16 least significant bits of the product A×B.

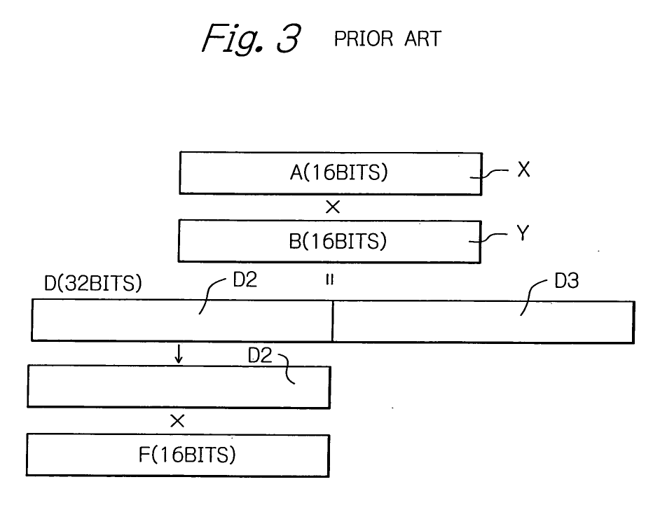

Referring now to FIG. 3, a description will be given on a method that does not take into account the 16 least significant bits of the product A×B as a comparative example. FIG. 3 outlines the operation processing of the comparative example. The comparative example also provides the product A×B×F of the sets of data A, B and F. All of the data A, B, and F are of 16 bits. The comparative example also provides the product of the data F and the 16 most significant bits of data D2 of the 32 bits of resultant product data D (=A×B). However, the 16 least significant bits of data D3 of the product D is not held in any register to be lost. The processing thus disregards the product of the data F and the 16 least significant bits of data D3 of the product D, thereby providing a lower computation precision than the illustrative embodiment shown in and described with reference to FIG. 2. More specifically, errors may be involved during the operation because the operation does not reflect the 16 least significant bits of the product D. The least significant bit of the final result does not reflect the 16 least significant bits of the product D at all. The comparative example does not round off but truncate the 16 least significant bits.

Referring now to FIGS. 4 and 5, the illustrative embodiment will be described in more detail. FIG. 4 is a schematic block diagram of the operational processor 18. FIG. 5 is a timing chart of the operational processor 18. The operational processor 18 performs the operation processing at an operation cycle synchronized with a system clock signal, not shown. The operational processor 18 includes a control section 100 which is adapted to control the data input and output to and from the registers. Control lines between each register and the control section 100 are not shown for the purpose of simplicity. First, from an external memory, not shown, 16-bit data A and 16-bit data B are transferred to a register X 21 and a register Y 23, respectively, in the order of the data A and data B over signal lines 20 and 22 that are connected to a CPU bus, also not shown. The data A and B are transferred in cycle Nos. 1 and 2, respectively. The register X 21 and register Y 23 hold the transferred data A and B, respectively.

In FIG. 4, the symbols in the parentheses after the reference numerals designating the signal lines indicate data transferred on the signal line. A plurality of symbols in the parentheses on a signal line mean that a corresponding plurality of data are transferred sequentially in the corresponding order on the signal line. For example, the symbol (B, F) of the signal line 22 shows that the data B and F are transferred in this order. Note, however, that the data B and F are not necessarily transferred at continuous cycles. FIG. 5 shows the transfer timing.

The 16-bit data A and B held in the registers X and Y, respectively, are sent over the signal lines 24 and 26 to the multiplier A 28. The multiplier A 28 multiplies the data A and data B to provide 32-bit data D (=A×B) in cycle No. 3. Because the CPU bus has the width of 16 bits, actually the 16 most significant bits of data D2 of the data D are sent over the signal line 30 to the register X21 as a computation result in cycle No. 4. The register X 21 holds the data D2.

In cycle No. 4, only the n most significant bits of data D1 of the 16 least significant bits of the data D are sent on the signal line 32 to the status register 10. The status register 10 holds the data D1 in its reserved bit positions C1-Cn. The data F are transferred to the register Y23 on the CPU bus and signal line 22.

In cycle No. 5, the 16 most significant bits of data D2 of the data D and the 16-bit data F held in the register Y23 are sent on the signal lines 24 and 26 to the multiplier A 28, which in turn multiplies the data D2 and data F to provide 32-bit data G (=F×D2). In cycle No. 6, the 16 most significant bits of data G2 of the data G are transferred over the signal line 34 to the register ZA 35, which in turn holds the data G2. The 16 least significant bits G1 of the data G are sent on the signal line 36 to the register T 37, which in turn holds the data G1.

In cycle No. 5, the data D1 and 16-bit data F held in the register Y 23 are sent on the signal lines 38 and 40 to the multiplier B 42, which then multiplies the data D1 and data F to provide 32 or less bits of data (=F×D1). More specifically, an operation of F/2×Cn+ . . . +F/2ⁿ×C1 is performed. In cycle No. 6, only the 16 most significant bits of data G3 of the resulting data are transferred on the signal line 44 to the register ZB 46, which will hold the data G3.

In cycle No. 7, the data G1 in the register T 37 and the data G3 in the register ZB 46 are sent on the signal lines 48 and 50 to the ALU 52, which in turn adds the data G1 and G3 to each other to provide data G4. In cycle No. 8, the data G4 is sent over the signal line 54 to the register ZB 46. The register ZB 46 then holds the data G4.

In cycle No. 9, the data G2 in the register ZA 35 and the data G4 in the register ZB 46 are sent over the signal lines 56 and 50 to the ALU 52, which adds the data G2 and G4 to each other to provide resultant data G5. The data G5 is the product of A×B×F. In cycle No. 10, the data G5 is sent on the signal line 58 to the register ZC 60. The register ZC 60 in turn holds the data G5. The data G5 is then outputted outside from the signal line 62 connected to the CPU bus.

As described above, the illustrative embodiment uses the bit positions C1-Cn in the status register to secure information that is originally intended to be deleted, thereby providing a higher operation precision.

The present embodiment also has the following advantages. In a method in which the bit positions C1-Cn would not be used, but the 32-bit data resulting from the multiplication of sets of 16-bit data would be divided into 16 most significant bits and 16 least significant bits to store both of them separately in two general-purpose registers, the 16 least significant bits held in the one general-purpose register would have to be additionally stored in a memory at an interrupt or task switching. An additional period of time would thus be needed for the 16 least significant bits to be stored. The embodiment of the present invention provides the bit positions C1-Cn in the status register which utilize the bit positions that were conventionally reserved. There is thus no need to provide additional facility for storing the 16 least significant bits. Time otherwise required for saving the 16 least significant bits may thus be eliminated, thereby reducing time otherwise needed for the task switching or the like.

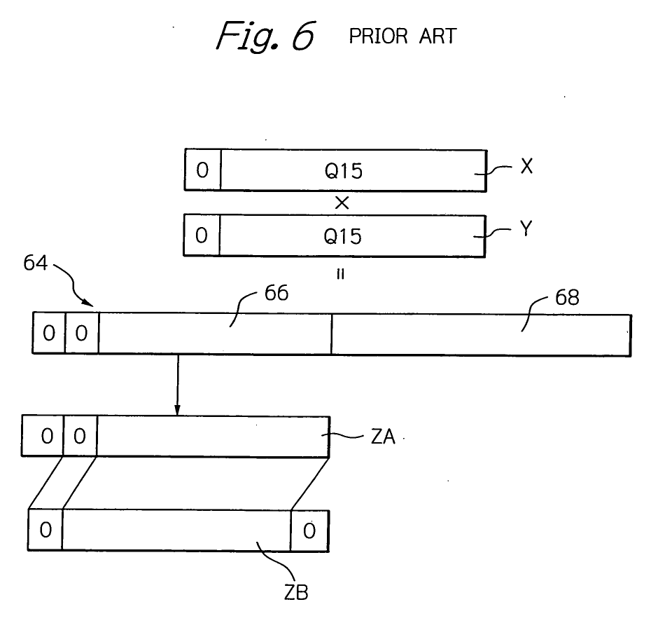

An alternative embodiment of the present invention will be described below. The alternative embodiment may improve the operation precision in the fixed decimal point representation when, for example, a data size of less than 16 bits is specified for the CPU bus of 16 bits. Before describing the alternative embodiment, as another comparative example, an operation method will be described which has a lower operation precision than the alternative embodiment, referring to FIG. 6.

Consider multiplication of sets of 15-bit data (again referred to as Q15 data) held in the registers X and Y. The most significant bit in the registers X and Y is “0”. The multiplication of the data held in the registers X and Y with each other provides 32-bit data 64 with the two most significant bits being “00”. The 16 most significant bits of data 66 of the 32-bit data 64 are outputted to the register ZA as the intermediate result of the operation processing. The two most significant bits of the 16-bit data are “00”. The 16 least significant bits of data 68 are discarded.

Because the most significant bit of the 16 most significant bits of data 66 is unnecessary, the operation result is shifted to the left by one bit position. The least significant bit position receives “0”. The final result thus enters the register ZB. The shift to the left would have to provide the least significant bit position of the 16 most significant bits with the most significant bit of the 16 least significant bits of data 68. The 16 least significant bits are discarded, however, during computation, so that the shift to the left does not insert the most significant bit of the 16 least significant bits into the 16 most significant bits of data. For the operation of Q14×Q14, Q13×Q13 and so on, more bits are shifted, so that more errors may occur, accordingly.

The data 68 are information that will be lost in the fixed decimal point operation. The shift performed during computation does not reflect the most significant bit of the data 68. The present invention however holds the most significant bit of the data 68 in the status register for use in the computation. The computation precision may be increased, accordingly. It is to be noted that for the operation of Q14×Q14, Q13×Q13 and so on, the present invention provides more bit positions to be shifted, i.e., two, three or more bit positions to be shifted.

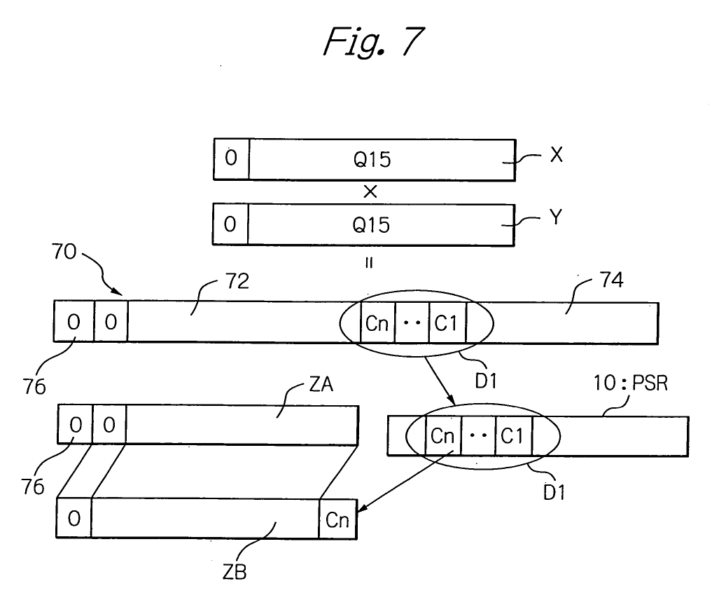

FIG. 7 outlines the operation processing of the alternative embodiment of the invention. A multiplier multiplies the Q15 data held in the register X and the Q15 data held in the register Y to provide 32-bit data 70. Because the CPU bus has its width of 16 bits, only the 16 most significant bits of data 72 are held in the register ZA. The status register 10 holds the n most significant bits of data D1 of the lower bit data 74 in the bit positions C1-Cn.

Because the most significant bit 76 of the 16 most significant bits of the resulting data 70 provided by the multiplier is unnecessary, the value of the register ZA is shifted to the left by one bit position. This left shift also introduces the value in the bit position Cn secured in the status register 10 into the least significant bit position from the lower bit position. Actually, the alternative embodiment shifts the value of the register ZA to the left by one bit position, and then adds the value of the bit positions Cn-C1 secured in the status register 10 to the shifted value according to the values in the bit positions Cn-C1. The data 74, which would be conventionally intended to be lost, may increase the computation precision, corresponding to the bit position Cn.

Likewise, to the operations of Q14, Q13 and so on, the amount of shift from the lower bit positions during computation is proportional. For the operations of Q14×Q14, Q13×Q13 and so on, shift is made on more bit positions, so that more values are taken from the corresponding bit positions of the status register. Note that the alternative embodiment also saves the value of the status register upon task switching during operation, as in the conventional technology.

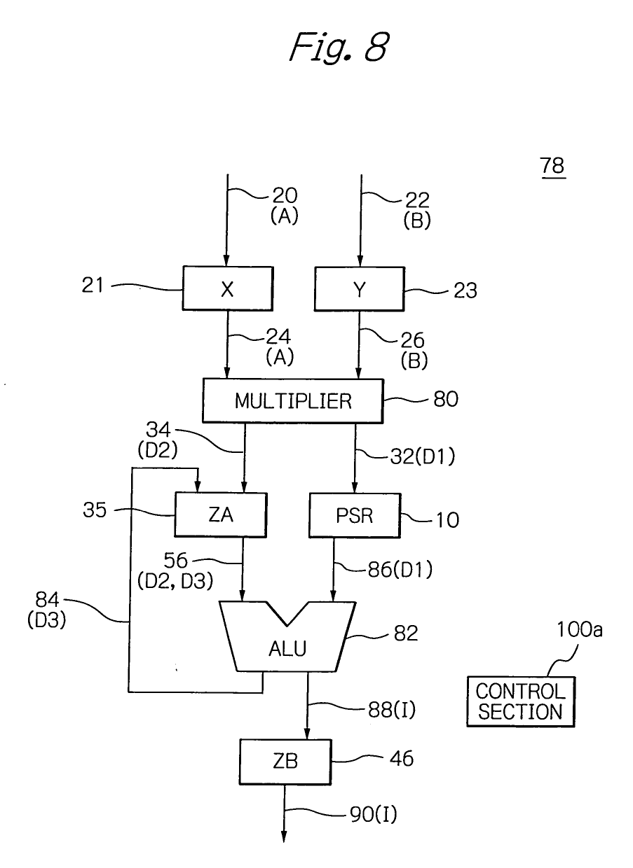

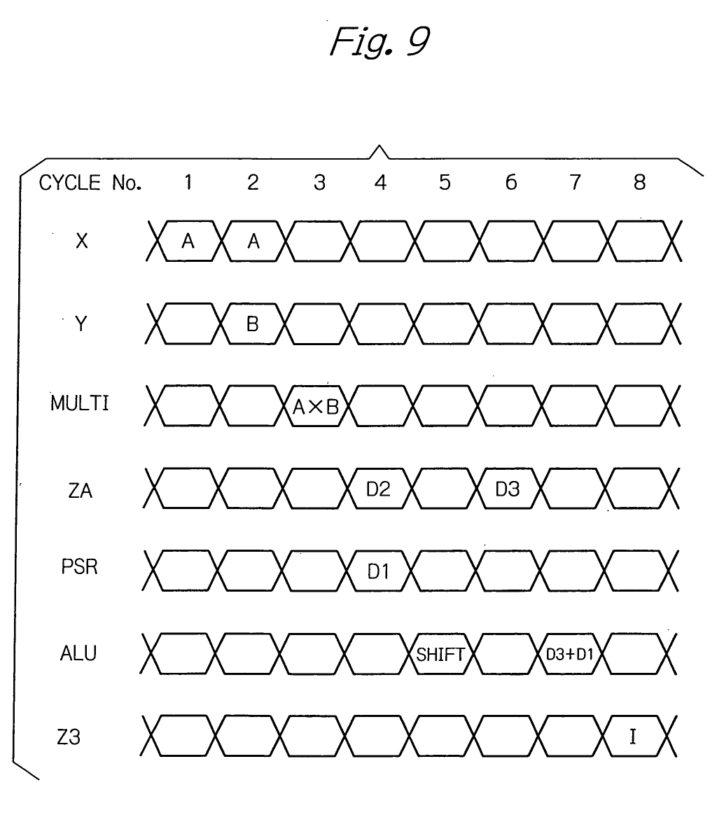

Referring now to FIGS. 8 and 9, the alternative embodiment will be described in more detail. FIG. 8 is a schematic block diagram of the operational processor 78. FIG. 9 is a timing chart of the operational processor 78. Like elements are designated with the same reference numerals in the figures. The operational processor 78 performs the operation processing at an operation cycle synchronized with a system clock signal, not shown. The control section 100a is adapted to control the data input and output to and from the registers.

First, from an external memory, not shown, 16-bit data A and B are transferred to the register X 21 and the register Y 23, respectively, in the order of the data A and B on the signal lines 20 and 22 connected to a CPU bus, also not shown. The data A and B are transferred in cycle Nos. 1 and 2, respectively. The register X 21 and register Y 23 hold the transferred data A and B, respectively. In FIG. 8, the symbols in the parentheses following the reference numerals designating the signal lines mean the same as in FIG. 4.

The 16-bit data A and B held in the registers X 21 and Y 23, respectively, are sent over the signal lines 24 and 26 to the multiplier 28, respectively. The multiplier 80 multiplies the data A and data B to provide 32-bit data D (=A×B) in cycle No.

3. Because the CPU bus has its width of 16 bits, actually the 16 most significant bits of data D2 of the data D are sent on the signal line 34 to the register ZA 35 as a computation result in cycle No.

4. The register ZA 35 holds the data D2.

In cycle No. 4, only the n most significant bits of data D1 of the 16 least significant bits of the data D are sent over the signal line 32 to the status register 10. The status register 10 holds the data D1 in the bit positions C1-Cn.

In cycle No. 5, the 16 most significant bits of data D2 of the data D are sent on the signal line 56 to the arithmetic and logical unit 82, which in turn shifts the data D2 to the left by one bit position. The resulting data D3 are sent over the signal line 84 to the register ZA 35 in cycle No. 6. The register ZA 35 holds the data D3.

The data D3 held in the register ZA 35 and the data D1 held in the status register 10 are sent over the signal lines 56 and 86 to the arithmetic and logical unit 82. The arithmetic and logical unit 82 adds the data D3 and data D1 to each other to provide 16-bit data I in cycle No. 7. The data I are sent on the signal line 88 to the register ZB 46 in cycle No. 8. The register ZB 46 in turn holds the data I. The data I are then outputted outside from the signal line 90 connected to the CPU bus.

As described above, the alternative embodiment uses the bit positions C1-Cn provided in the status register to secure information that would originally have been deleted, thereby providing the more accurate operation result. The alternative embodiment has the following advantages as in the embodiment shown in and described with reference to FIG. 4. In a method which divides 32-bit data resultant from multiplying sets of 16-bit data with each other into the 16 most significant bits and the 16 least significant bits and store both separately into the respective registers, task switching or the like additionally requires the 16 least significant bits to be saved in a memory. An additional period of time is thus needed for storing the 16 least significant bits. The alternative embodiment of the invention provides the bit positions C1-Cn in the status register that are prepared in the reserved field, so that there is no need to prepare an additional storage area for the 16 least significant bits. The time for saving the 16 least significant bits may thus be eliminated, thereby reducing the time needed for the task switching or the like.

Although the above-described embodiments are directed to the multiplication and shift operation by way of example performed by the information processor such as a microcontroller that uses the n most significant bits of the 16 least significant bits of the 32-bit data resulting from the operation to increase the operation precision, the present invention is not limited to the above-described operations. The present invention may be applied to any operation in which an operational result is obtained which has its effective data length exceed the bit length of a general-purpose register and the lower bits of data may be incorporated to increase the operation precision. The present invention may also be applied to any types of operational processor and information processor that perform such operations.

The entire disclosure of Japanese patent application No. 2005-260581 filed on Sep. 8, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. An operational processor comprising a data register for holding data associated with operation processing, and a status information register for holding information associated with a status of said operational processor, the data and information being saved from said data register and status information register to an external storage at least during task switching, wherein
said status information register holds a portion of data resulting from the operation processing, the held portion of data being at least a portion of lower bits of the data resulting from the operation processing, the lower bits not being held in said data register,
said operational processor further comprising:
a circuit for allowing said status information register to hold the portion of the data; and
a circuit for allowing said status information register to output the portion of the data.

2. The operational processor in accordance with claim 1, wherein
the data resulting from the operation processing has a data length longer than a data length that said data register can hold,
said data register holding upper bits of the data resulting from the operation processing which correspond to the data length that said data register can hold,
said status information register holding n most significant bits of lower-bit data not held in said data register, where n is a natural number.

3. The operational processor in accordance with claim 1, wherein
said data register holds upper bits of the data resulting from the operation processing which are of a length shorter than the data length that said data register can hold,
said status information register holding n most significant bits of lower-bit data not held in said data register, where n is a natural number.

4. The operational processor in accordance with claim 1, wherein said data register is a general-purpose register, and said status information register is a program status register.

5. The operational processor in accordance with claim 4, wherein said program status register holds the portion of the data in a reserved area that is a free space of said program status register.

6. An information processor comprising a plurality of registers for holding data that are an intermediate result or a final result of operation processing, the data held in said plurality of registers being temporarily saved in a memory at least during task switching, and first one of said plurality of registers being a program status register for storing at least a flag determined by the operation processing result, wherein
the data held in said plurality of registers have a data length longer than a resister length of at least second one of said plurality of registers other than said program status register,
said program status register having a hold area for holding n most significant bits of lower bits of the data which have the data length longer than the resister length, the lower bits not being held in said second register, where n is a natural number,
said information processor further comprising:
a circuit for holding the n most significant bits in the hold area; and
a circuit for outputting the held data from the hold area.
